(19) United States
(12) Patent Application Publication
(10) Pub. No.: US 2015/0058338 A1
(43) Pub. Date: Feb. 26, 2015

(54) PROMOTING ACTIVITY DURING PERIODS OF SEDENTARY BEHAVIOR

(71) Applicant: Intel Corporation, Santa Clara, CA (US)

(72) Inventors: Daniel Avrahami, Mountain View, CA (US); Jaeyeon Jung, Kirkland, WA (US); Sunny Consolvo, Mountain View, CA (US)

(73) Assignee: Intel Corporation, Santa Clara, CA (US)

(21) Appl. No.: 13/995,579

(22) PCT Filed: Dec. 28, 2011
(86) PCT No.: PCT/US11/67682

§ 371 Date: Oct. 13, 2014

(51) Int. Cl. H04L 29/08; G06F 17/30

(52) U.S. Cl. CPC H04L 67/22; G06F 17/30943; G06F 17/30595
USPC 707/736

(57) ABSTRACT

Systems and methods of operating a computing system may involve determining an identity of a user, determining physical attributes of a user, monitoring user activity, intelligently interrupting sedentary user activity after a threshold period of time has passed, and proposing activities to break the sedentary period of user behavior.

### BACKGROUND

1. Technical Field

Embodiments generally relate to promoting breaks during sedentary user behavior. More particularly, embodiments relate to promoting breaks in sedentary user behavior by interrupting the user's sedentary activity and suggesting a physical activity.

2. Discussion

Medical studies have shown that long periods of sedentary behavior may have negative health consequences. In many cases, utilizing consumer electronic devices may require a user to be stationary. Therefore, promoting activity during use of these devices may be beneficial.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a computing system configured to promote activity during sedentary user behavior in accordance with an embodiment of the invention; and

FIG. 2 is a flowchart of an example of a method of promoting activity during sedentary user behavior in accordance with an embodiment of the invention.

### DETAILED DESCRIPTION

Embodiments may include a system including a camera to capture a camera feed and an activity promoting platform including a memory device to store a first activity promoting application. The first activity promoting application may be configured to determine a presence of a user, determine a physical attribute of the user, monitor activity of the user, interrupt a period of sedentary user behavior, and propose an activity to the user. The system may also include a database to store at least one of a second activity promoting application, a software update to the first activity promoting application, and a supplemental information store.

Embodiments may also include an apparatus comprising an activity promoting platform including a memory device to store at least one of a first activity promoting application. The activity promoting application may be configured to determine a presence of a user, determine a physical attribute of the user, monitor activity of the user, interrupt a period of sedentary user behavior, and propose an activity to the user.

Additional embodiments may include a method comprising determining a presence of a user, monitoring activity of the user, and determining a physical attribute of the user. The method may also provide for determining an identity of the user, interrupting a period of sedentary user behavior, and proposing an activity to the user, wherein the proposing the activity to the user includes displaying a message on a display device.

In addition, embodiments may include a computer readable storage medium comprising a set of instructions, which, if executed by a processor, cause a computer to determine a presence of a user, monitor activity of the user, and determine a physical attribute of the user. The set of instructions may also cause a computer to determine an identity of the user, interrupt a period of sedentary user behavior, and propose an activity to the user, wherein the proposing the activity to the user includes displaying a message on a display device.

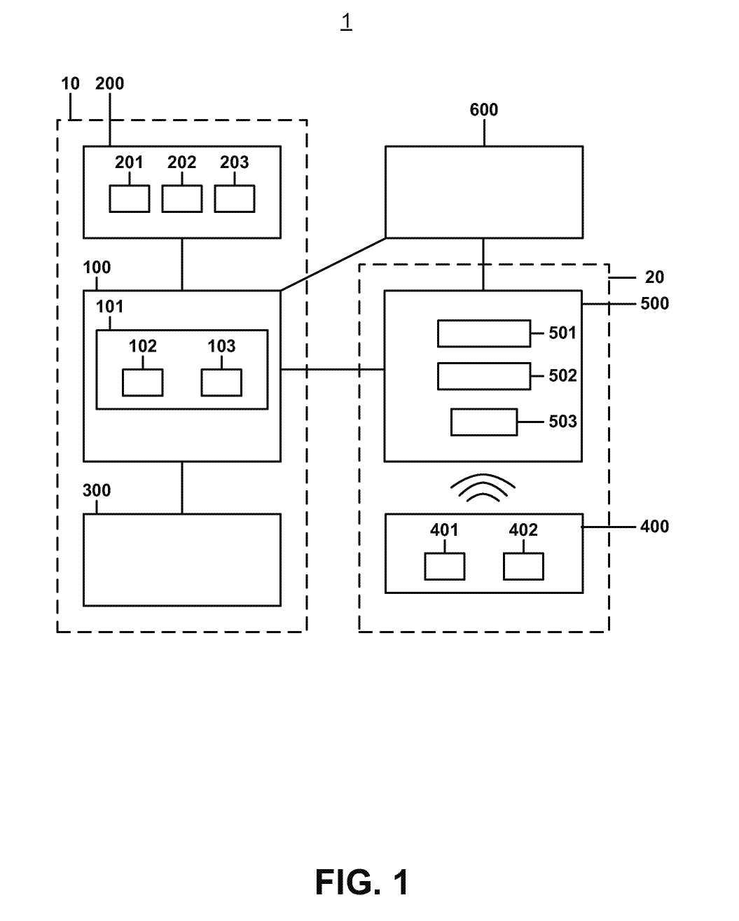

Turning now to FIG. 1, a block diagram of a computing system 1 is shown. The computing system 1 may include an activity promoting system 10, a content system 20, and an interface device 600. The content system 20 may include a content platform user device 400 and a content platform 500.

The content platform user device 400 may be any device configured to communicate with at least one of the activity promoting system 10 and the content platform 500. The content platform user device 400 may include an input mechanism 401 and an input device transmitter 402. The input mechanism 401 (e.g., a touchpad, an action button) may be used to input data or instructions to one of the activity promoting system 10 and the content platform 500. The input device transmitter 402 may be used to transmit data from the content platform user device 400 to one of the activity promoting system 10 and the content platform 500. For example, the content platform user device 400 may be a television remote control that is configured communicate using infrared. Or, the content platform user device 400 may be a video game controller that may communicate with other devices (e.g., printer 302) via a wireless data connection e.g., IEEE 802.11, 1999 Edition, LAN/MAN Wireless LANS (WiFi), IEEE 802.16-2004, LAN/MAN Broadband Wireless LANS (WiMAX), etc.), a cellular telephone connection (e.g., W-CDMA (UMTS), CDMA2000 (IS-856/IS-2000), etc.), a wired data connection (e.g., RS-232 (Electronic Industries Affiance/EIA), Ethernet (e.g., IEEE 802.3-2005, LAN/MAN CSMA/CD Access Method), power line communication (e.g., X10, IEEE P1675), USB (e.g., Universal Serial Bus 2.0 Specification)), etc., depending upon the circumstances.

The content platform 500 may be any electronic device configured to deliver content. For example, the content platform 500 may be a computer desktop, a computer notebook, a video game console, a television cable or set-top box, a tablet computer, or a portable DVD player. The content platform 500 may include a content platform memory 501, a content platform operating system (OS) 502, and a content platform receiver 503. The content platform memory 501 may be utilized to, among other things, store data. For example, the content platform memory 501 may record content being enjoyed by a user. The content platform OS 502 may be a computer program that manages the operation of the content platform 500. The content platform receiver 503 may be configured to receive wireless communications from the content platform user device 400.

The interface device 600 may be coupled to the content platform 500, and may display the content delivered by the content platform 500. The interface device 600 may be, among other things, a computer monitor or smart tablet device screen.

The activity promoting system 10 may be configured to, among other things, interrupt a sedentary user activity and propose a physical activity. The activity promoting system may 10 include an activity-promoting platform 100, a database 200, and a camera device 300. The activity-promoting platform 100 may include a memory device 101. The memory device 101 may store, among other things, a first activity promoting application 102 and a user account 103. As will be discussed in greater detail, the first activity promoting application 102 may include software algorithms configured to, among other things, determine an identity of a user, determine physical attributes of a user, monitor user activity, intelligently interrupt sedentary user activity after a threshold period of time has passed, and propose activities to break the sedentary period of user behavior. The user account 103 may store personal information pertaining to a user (e.g., age, gender, weight), and may be utilized to suggest a proper activity for a user.

The database 200 may store, among other things, a second activity promoting application 201 and a software application update 202 for the first activity promoting application 102. In addition, it may also include a supplemental information store 203. An activity promoting application, such as the first activity promoting application 103 may access the supplemental information store 203 to aid in suggesting proper activities to break a period of sedentary user behavior. Examples of the supplemental information in the supplemental information store 203 may include demographic preferences and medical records or data.

The camera 300 may capture a feed, and may be used to monitor user behavior. For example, the camera 300 may be a video camera device. The camera 300 may be configured to capture two-dimensional (2D) images or video, or may be configured to capture three-dimensional (3D) images or video by utilizing, for example, an infrared (IR) transmitter.

More particularly, in the case of 3D video capture, the camera 300 may capture depth information to generate a 3D images or video. In sonic cases, the first activity promoting application 102 may utilize the depth information to determine the user's physical attributes (e.g., weight, age, gender etc.) more simply and accurately than in the case of 2D video capture. Indeed, in some cases, the depth information acquired may be sufficient in itself in determining various physical attributes of the user, thereby better preserving the user's privacy.

Turning back to the first activity promoting application 102, it may be configured to start up at various times of use, and may be initiated by various entities. For example, the first activity promoting application 102 may be initiated upon startup of the content platform 500 by the content platform OS 502, or may be initiated during the operation of the content platform 500 by the user by using the content platform user device 400.

The first activity promoting application 102 may monitor user activity by analyzing the feed delivered the camera 300 to determine the presence of a user, and to determine the degree of activity that a user exhibits by, for example, analyzing the video feed for user movement. The first activity promoting application 102 may determine the physical attributes of the user by, among other things, analyzing the feed captured from the camera 300. For example, the first activity promoting application 102 may analyze a 3D video feed to determine depth aspects of an image, and utilize the depth information to determine physical attributes of the user, such as age, sex, or weight.

The first activity promoting application 102 may also determine the identity of a user by utilizing at least one of analyzing the camera feed and consulting the user account 103. For example, if the user has a user account, such as the user account 103, the first activity promoting application 102 may used the determined physical attributes of the user to associate a user account, such as user account 103. The first activity promoting application 102 may then propose preferred activities specific to that user.

In other cases, while the first activity promoting application 102 may be able to determine physical attributes (e.g., weight, age, gender etc.) of the user, it may not be able to associate it with a user account (e.g., the user does not have a user account). In these cases, the first activity promoting application 102 may suggest an appropriate activity based on the gathered physical attributes. In still other cases, the first activity promoting application may analyze the gathered physical attributes and consult the database 200 before suggesting an appropriate user activity.

So, for example, if the user is a young child with a user account 103 on the activity promoting platform 100, the first activity promoting application 102 may determine the physical attributes of the child, consult the user account 103 to confirm his identity, determine that the child prefers dance, and propose an interactive music and dance game as a physical activity. If, on the other hand, the first activity promoting application 102 determines the user is a middle-aged woman of average height and weight with no user account, it may consult the supplemental information store 203 on the database 200 to determine that an appropriate physical activity for the user may be a yoga routine.

The first activity promoting application 102 may also analyze the content being broadcast by the content platform 500 to determine an appropriate time to intelligently interrupt the user's activity. Determining an appropriate time to intelligently interrupt the user's activity may include determining a break in the activity in which the user is participating. For example, if the user is viewing a live television broadcast, the first activity promoting application 102 may interrupt during a commercial break. If the user is working on a document in a word processing application, the first activity promoting application 102 may interrupt after the user has saved the document. In the case of a video game, the first activity promoting application 102 may interrupt when the user moves from one play level to another.

Furthermore, the first activity promoting application 102 may intelligently interrupt the user's activity after a threshold condition is met. The threshold condition may be predetermined period of time (e.g., thirty minutes), or may be based on the progress of the user's activity (e.g., after the user has completed three levels of play in a video game). After the threshold condition is met, the first activity promoting application 102 may generate a message (e.g., a popup screen on a display) to the user to propose a physical activity. The first activity promoting application 102 may also intelligently interrupt the user's sedentary activity while preventing any loss or harm in the user's experience. Preventing loss or harm in the user's experience may include saving content being consumed by the user at a memory device, such as the content platform memory 501. For example, if the user is watching streaming content (e.g., television programming), the first activity promoting application 102 may properly halt the user's activity by pausing the television programming broadcast, and begin recording the television broadcast at the content platform memory 501 for later viewing. Similarly, if the user is working on a document a word processing application, the first activity promoting application 102 may save the document automatically upon interrupting.

The arrangement and numbering of blocks depicted in FIG. 1 is not intended to imply an order of operations to the exclusion of other possibilities. Those of skill in the art will appreciate that the foregoing systems and methods are susceptible of various modifications and alterations.

For example, in the embodiment described in FIG. 1, the first activity promoting application 102 may utilize, among other things, the physical attributes of the user to propose an activity. However, in other embodiments, the first activity promoting application may also propose an activity based on the content of the user's sedentary activity. For example, if the user is watching a sporting event (e.g., a basketball game), the first activity promoting application 102 may suggest the user play basketball. If on the other hand, the user is writing on a word processing application, the first activity promoting application 102 may suggest a short walk.

Moreover, in the embodiment described in FIG. 1, the activity promoting platform system 10 may be separate from and coupled to the content platform 500. However, in other embodiments, the activity promoting system may be integrated into the content platform.

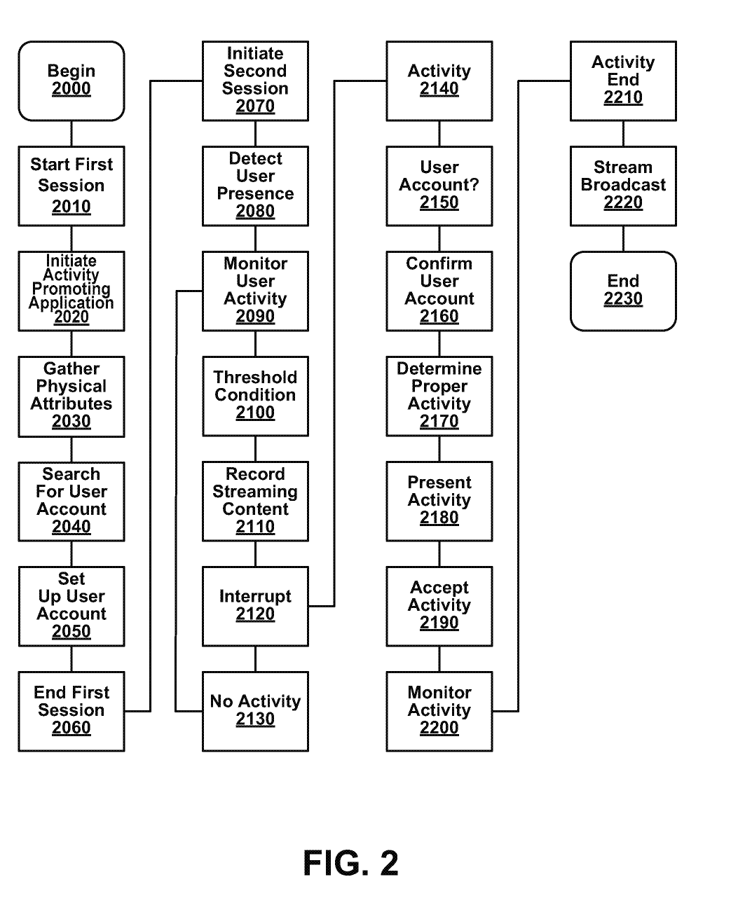

Turning now to FIG. 2, a flowchart of an example of a method of promoting activity during sedentary user behavior in accordance with an embodiment of the invention is shown. The method might be implemented as a set of logic instructions stored in a machine- or computer-readable storage medium such as random access memory (RAM), read only memory (ROM), programmable ROM (PROM), firmware, flash memory, etc., in configurable logic such as programmable logic arrays (PLAs), field programmable gate arrays (FPGAs), complex programmable logic devices (CPLDs), in fixed-functionality logic hardware using circuit technology such as application specific integrated circuit (ASIC), complementary metal oxide semiconductor (CMOS) or transistor-transistor logic (TTL) technology, or any combination thereof. For example, computer program code to carry out operations shown in the method may be written in any combination of one or more programming languages, including an object oriented programming language such as Java, Smalltalk, C++ or the like and conventional procedural programming languages, such as the “C” programming language or similar programming languages.

The process may begin at processing block 2000. At processing block 2010, a user may begin a first use session at a content platform, such as the content platform 500 (FIG. 1). In this case, the content platform may be a desktop computer, and the first use session may he a viewing of a streaming webcast. At processing block 2020, a content platform operating system, such as the content platform operating system 502 (FIG. 1), may initiate an activity promoting application, such as the first activity promoting application 102 (FIG. 1), upon startup of the first use session.

At processing block 2030, the activity promoting application may utilize a camera, such as the camera 300 (FIG. 1), to determine the presence of the user and to determine the user's physical attributes (e.g., age, gender, weight etc.). At processing block 2040, the activity promoting application may utilize the gathered physical attributes to search for a user account, such as the user account 103 (FIG. 1). At processing block 2050, upon determining a user account for the user does not exist, the activity promoting application may prompt the user to set up a user account. The setup process may require the user to enter new information, or modify the physical attributes determined by the activity promoting application. In addition, the user may also enter personal preferences, such as physical activities the user enjoys, and how long the user typically enjoys them. At processing block 2060, the activity promoting application may be closed after the user logs off.

At a later time, the user may return to enjoy a second use session at the content platform. The second session may be a viewing of a live streaming broadcast of a sporting event. At processing block 2070, the content platform may initiate the activity promoting application upon startup of the second use session. At processing block 2080, the activity promoting application may utilize the camera to detect the presence of the user, determine the user's physical attributes, access the user's user account, and confirm the identity of the user. At processing block 2090, the activity promoting application may monitor the activity of the user.

At processing block 2100, after a threshold. condition has been met (e.g., 30 minutes of sedentary user behavior), the activity promoting application may determine the need to interrupt the live streaming broadcast. At processing block 2110, the activity promoting application may begin recording the live streaming broadcast using a content platform memory, such as the content platform memory 501 (FIG. 1).

At processing block 2120, the activity promoting application may interrupt the user's viewing of the live streaming broadcast. For example, as discussed above, the activity promoting application may generate and display a message (e.g., a popup message) on a display device, such as the interface display device 600 (FIG. 1), at an appropriate time (e.g., during a commercial break). The message may include various information. For example, the message may indicate its purpose is to propose physical activity, may inform the user that the live streaming broadcast is being recorded for later viewing, and may inquire whether the user would like to take part in a physical activity.

If the user prefers not to, at processing block 2130, the user may indicate so by utilizing a user device, such as the content platform user device 400 (FIG. 1). At this point, the process may return to processing block 2090. If, on the other the hand, the user agrees to take part in a physical activity, the user may, at processing block 2140, indicate so by utilizing the user device, and the process continues to processing block 2150.

At processing block 2150, the activity promoting application may inquire whether the user is the person associated with a user account (e.g., the user account created at processing block 2050). At processing block 2160, the user may confirm the user account using the user device. At processing block 2170, the activity promoting application may determine a proper activity by consulting, among other things, the user account.

At processing block 2180, the activity promoting application may present the determined proper activity to the user, along with an option to be presented with another activity if the determined property activity is not to the user's liking. For example, the activity promoting application may suggest the user play a music-dance video game for twenty minutes.

At processing block 2190, the user may use the user device to indicate that the proposed activity is to the user's liking. At processing block 2200, the activity promoting application may utilize the camera to monitor the user's activity, track the user's accomplishments, and offer feedback in real-time. For example, the activity promoting application may generate a message of encouragement after every five minutes of monitored user activity.

At processing block 2210, the activity promoting application may indicate that that the time period for activity is over. At processing block 2220, the activity promoting application may utilize the recorded content to display the streaming broadcast from the time the live streaming broadcast was paused. At processing block 2230, the process may terminate.

The sequence and numbering of blocks depicted in FIG. 2 is not intended to imply an order of operations to the exclusion of other possibilities. Those of skill in the art will appreciate that the foregoing systems and methods are susceptible of various modifications, variations, and alterations.

For example, in the embodiment described in FIG. 2, a single user utilized the activity promoting application. However, in other embodiments, the activity promoting application may accommodate groups of users. Specifically, upon determining an excessive amount of sedentary user behavior amongst the group, the activity promoting application may propose may propose a group activity based on various information (e.g., physical attributes of the individual group members, user accounts of the group members, etc.). Alternately, in another embodiment, in the case of two users that both have user accounts, the activity promoting application may utilize the user account preferences for both to determine an activity that both users will enjoy. In addition, the activity promoting application may recognize a social event (e.g., based on the number of users, the content being viewed), and not propose an activity despite sedentary behavior by the group.

It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

In addition, in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding. Any represented signal lines, whether or not having additional information, may actually include one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details are set forth in order to describe example embodiments of the invention, it should be apparent to one skilled in the art that embodiments of the invention can be practiced without, or with variation of these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. are used herein only to facilitate discussion, and carry no particular temporal or chronological significance unless otherwise indicated.

We claim:

1. A system comprising:
a camera to capture a camera feed;
an activity promoting platform including a memory device to store a first activity promoting application, wherein the first activity promoting application is configured to:
determine a presence of a user;
determine a physical attribute of the user;
monitor activity of the user;
interrupt a period of sedentary user behavior; and
propose an activity to the user; and
a database to store at least one of a second activity promoting application, a software update to the first activity promoting application, and a supplemental information store.

2. The system of claim 1, wherein the memory device stores a user account.

3. The system of claim 2, wherein the first activity promoting application is further configured to determine an identity of the user, wherein determining the identity of the user includes at least one of analyzing the camera feed and consulting the user account.

4. The system of claim 2, wherein the first activity promoting application proposes the activity to the user based on at least one of the user account, the physical attribute, and the supplemental information store.

5. The system of claim 1, wherein the first activity promoting application interrupts the period of sedentary user behavior based on a threshold condition.

6. The system of claim 1, wherein interrupting the period of sedentary user behavior includes determining a break in the user activity.

7. The system of claim 1, wherein interrupting the period of sedentary user behavior includes saving content at the memory device.

8. The system of claim 1, wherein the activity promoting platform is coupled to a content platform.

9. The system of claim 1, wherein the activity promoting platform is integrated into a content platform.

10. An apparatus comprising:
an activity promoting platform including a memory device to store at least one of a first activity promoting application, wherein the activity promoting application is configured to:
determine a presence of a user;
determine a physical attribute of the user;
monitor activity of the user;
interrupt a period of sedentary user behavior; and
propose an activity to the user.

11. The apparatus of claim 10, wherein the memory device stores a user account.

12. The apparatus of claim 11, wherein the first activity promoting application is further configured to determine an identity of the user, wherein determining the identity of the user includes at least one of analyzing a camera feed and consulting the user account.

13. The apparatus of claim 11, wherein the first activity promoting application proposes the activity to the user based on at least one of the user account, the physical attribute, and the supplemental information store.

14. The apparatus of claim 10, wherein the first activity promoting application interrupts the period of sedentary user behavior based on a threshold condition.

15. The apparatus of claim 10, wherein interrupting the period of sedentary user behavior includes determining a break in the user activity.

16. The apparatus of claim 10, wherein interrupting the period of sedentary user behavior includes saving content at the memory device.

17. The apparatus of claim 10, wherein the activity promoting platform is coupled to a content platform.

18. The apparatus of claim 10, wherein the activity promoting platform is integrated into a content platform.

19. A method comprising:
determining a presence of a user;
monitoring activity of the user;
determining a physical attribute of the user;
determining an identity of the user;
interrupting a period of sedentary user behavior; and
proposing an activity to the user, wherein the proposing the activity to the user includes displaying a message on a display device.

20. The method of claim 19, wherein determining the identity of the user includes at least one of analyzing a feed and consulting a user account.

21. The method of claim 19, wherein the period of sedentary user behavior is interrupted if a threshold condition is met.

22. The method of claim 19, wherein proposing the activity is based on at least one of the user account and the physical attribute.

23. The method of claim 19, wherein interrupting the period of sedentary user behavior includes determining a break in the user activity.

24. The method of claim 19, wherein interrupting the period of sedentary user behavior includes saving content at a memory device.

25. A computer readable storage medium comprising a set of instructions, which, if executed by a processor, cause a computer to:
determine a presence of a user;
monitor activity of the user;
determine a physical attribute of the user;
determine an identity of the user;
interrupt a period of sedentary user behavior; and
propose an activity to the user, wherein the proposing the activity to the user includes displaying a message on a display device.

26. The medium of claim 25, wherein determining the identity of the user includes at least one of analyzing a feed and consulting a user account.

27. The medium of claim 25, wherein the period of sedentary user behavior is interrupted if a threshold condition is met.

28. The medium of claim 25, wherein proposing the activity is based on at least one of a user account and the physical attribute.

29. The medium of claim 25, wherein interrupting the period of sedentary user behavior includes determining a break in the user activity.

30. The medium of claim 25, wherein interrupting the period of sedentary user behavior includes saving content at a memory device.
